(19) United States
(12) Patent Application Publication
(10) Pub. No.: US 2009/0297043 A1
(43) Pub. Date: Dec. 3, 2009

(54) PATTERN SCANNER AND EDITOR FOR SECURITY AUDIT SYSTEMS

(75) Inventors: Heather M. Hinton, Austin, TX (US); Ping Wang, Beijing (CN); Hang Xiao, Beijing (CN); Jean X. Yu, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/127,925

(22) Filed: May 28, 2008

(51) Int. Cl. G06K 9/68

(52) U.S. Cl. 382/219

(57) ABSTRACT

A pattern scanner is provided for identifying which portions of a security log entry is unrecognizable by currently defined data patterns. Furthermore, an editor is provided for identifying portions of the security log entry that are recognizable by sub-patterns of the currently defined data patterns and portions of the security log entry that are not recognizable. The editor further provides a user interface through which a user may associated sub-patterns with portions of the security log entry that are not recognized. Moreover, a user interface may be provided for defining new sub-patterns that may be applied to recognizing portions of security log entries. A data pattern based on a combination of sub-patterns for the recognized and unrecognized portions of the security log entry may then be automatically generated.

### BACKGROUND OF THE INVENTION

1. Field of the Invention

The present application relates generally to an improved data processing apparatus and method and more specifically to a pattern scanner and editor for security audit systems.

2. Background of the Invention

An Information Technology (IT) security audit is a technical process used to determine how an organization's IT security policy is employed in a specific network environment. Typically, security monitoring devices of a network environment, e.g., routers, firewalls, anti-virus software/hardware, host intrusion detection software/hardware, network intrusion software/hardware, etc., generate security events in response to detected conditions and store information about these generated security events in one or more raw security log files. Predetermined data patterns that describe the format of recognizable security log entries are used to parse the data in the raw security log files. Security agent software/hardware applies these predetermined data patterns to the raw security log files to extract information that is sent to a managing server for further processing, e.g., filtering and storage in a database, before it is presented to end users via end user consoles.

The data patterns used by the agents are generated by way of a manual process. That is, a human user specifies the pattern that he/she believes needs to be recognized by the agents in order to generate security information to be output to end users.

### BRIEF SUMMARY OF THE INVENTION

In one illustrative embodiment, a method, in a data processing system, is provided for processing a security log data structure entry. The method may comprise receiving an unrecognized security log entry. The unrecognized security log entry may be an entry in a raw security log data structure that is not able to be recognized by security audit agents based on already defined data patterns. The method may further comprise identifying first portions of the unrecognized security log entry that are recognized based on the already defined data patterns and second portions of the unrecognized security log entry that are not recognized. Moreover, the method may comprise providing a first user interface for receiving user input associating sub-patterns to the second portions of the unrecognized security log entry. The first user interface may identify the first portions of the unrecognized security log entry as being recognized. The method may also comprise generating a new data pattern based on the association of sub-patterns to the second portions of the unrecognized security log entry. The new data pattern may be applied to a subsequent security log entry in one or more raw security log data structures to thereby extract security event data for generation of a security event.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary diagram illustrating a distributed data processing system in which exemplary aspects of the illustrative embodiments may be implemented;

FIG. 2 is an exemplary block diagram of a data processing device in which exemplary aspects of the illustrative embodiments may be implemented;

FIG. 3 is an exemplary diagram illustrating the primary operational components of an Information Technology (IT) security audit system in accordance with one illustrative embodiment;

FIG. 4 is an exemplary diagram of a security log entry in a raw security log data structure in accordance with one illustrative embodiment;

FIG. 5 is an exemplary diagram of an exemplary pattern string in accordance with one illustrative embodiment;

FIG. 6 is an exemplary diagram of a security event generated based on a security log entry and a predetermined data pattern string in accordance with one illustrative embodiment;

FIG. 7 is an exemplary diagram illustrating a display of an editor view with a log attribute callout in accordance with one illustrative embodiment;

FIG. 8 is an exemplary diagram illustrating a display of an editor view in which callout boxes are collapsed in accordance with one illustrative embodiment; and

FIG. 9 is a flowchart outlining an exemplary operation for editing a security log pattern in accordance with one illustrative embodiment.

### DETAILED DESCRIPTION OF THE INVENTION

Today, Information Technology (IT) security departments are faced with ever growing security threats with these security threats being increasingly more sophisticated. As a result, raw security log file sizes have increased dramatically. In a middle sized data center, it is not uncommon to generate raw security log files having a size of 300 MB or more in a single hour of monitoring a network intrusion system. Moreover, new data formats appear constantly with new security devices and monitoring functionality. Security audit mechanisms must be able to detect new types of security events and parse raw security log data structures effectively.

Known security audit mechanisms are extremely inefficient due to their reliance on manual updating of these security audit mechanisms. That is, known security audit mechanisms rely on manual recognition of data formats in order to determine when new data patterns are present in raw security log data structures. That is, a user must manually look over the data patterns in a security log data structure with their own eyes and recognize that a new pattern is present in the raw security log data structure that requires a new data pattern to be defined for use by the agents of the security audit system. This is clearly inefficient even with the smallest of raw security log files but is even more so with the ever increasing sizes of modern raw security log files.

Moreover, in order to generate a new data pattern for use by an agent in processing a raw security log file, a human developer must manually enter a string to describe the newly recognized raw security log pattern. This process is error prone in that a single typographical error can lead to a failure to identify critical security log entries. Furthermore, expressing data patterns with plain text symbols sometimes makes it difficult to associate a criterion with its correct attribute.

The illustrative embodiments provide a mechanism to greatly reduce the pattern recognition/development efforts when generating new data patterns for use by security audit agents so that they can recognize new formats of security log entries. The mechanisms of the illustrative embodiments provide an ability to apply portions of previously defined data patterns to unrecognized raw security log file entries so that recognizable portions of the entries may be identified and unrecognized portions of the entries may be identified. The mechanisms of the illustrative embodiments further provide the ability to display, via a pattern editor interface, such unrecognized raw security log file entries in a manner where recognized and unrecognized portions of the entries are conspicuously displayed such that a user may easily discern between recognized and unrecognized portions. Moreover, the mechanisms of the illustrative embodiments provide a user interface through which a user may associate the unrecognized portions of the entries with categories of data pattern elements, e.g., event attribute types. The mechanisms of the illustrative embodiments provide the ability for a user to define new categories of data pattern elements for unrecognized portions of a security log entry which may then be stored and used with other unrecognized security log entries.

A data pattern for the unrecognized security log entry may then be automatically generated based on the recognized portions of the security log entry and the user's association of categories with the unrecognized portions of the security log entry. This data pattern may then be stored and used in processing other raw security log data structure entries.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

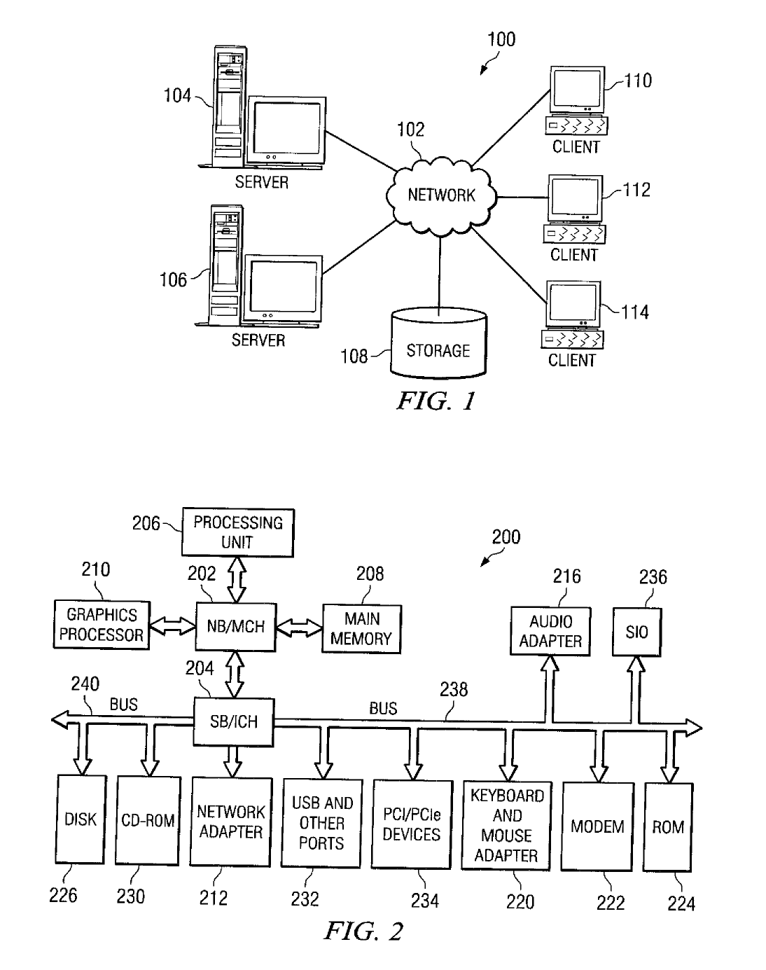

The illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as exemplary environments in which exemplary aspects of the illustrative embodiments may be implemented. While the description following FIGS. 1 and 2 will focus primarily on a distributed data processing environment implementation, this is only exemplary and is not intended to state or imply any limitation with regard to the features of the present invention. To the contrary, the illustrative embodiments are intended to include single data processing device environments or any other data processing environment in which security log data structures are processed to generate security events.

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

Referring again to FIG. 1, the distributed data processing system depicted in FIG. 1 or a subset of the elements shown in FIG. 1, may constitute an enterprise data processing system having a number of security monitoring devices (not shown) including routers, firewalls, host intrusion detection mechanisms, network intrusion mechanisms, and the like. Portions of the distributed data processing system, e.g., server 104, clients 110, 112, and 114, or the like, may have associated ones of these security monitoring devices, or these security monitoring devices may be separate elements within the data processing system. These security monitoring devices generate raw security log events based on detected occurrences within these security monitoring devices and store these raw security log events in one or more raw security log data structures.

The raw security log data structures may be processed by security software agents (hereafter “agents”) based on defined data patterns of security log entries that are recognizable by the agents. These agents may execute on the security monitoring devices themselves, in a server 104 or 106 based on a transmission of the raw security log data structures to the server 104 or 106, or may be provided in a computing device separate from the servers 104, 106 or the security monitoring devices. The agents generate security event information based on the recognized security log entries and provide this security event information to a security audit server, such as server 104 or 106. The security audit server generates security event entries in a security event database based on the security event information. These security event entries may then be used to generate notifications to an administrator via an administrator console so that the administrator is made aware of potential security issues within the data processing system.

The agents may not always be able to recognize a security log entry because a data pattern for the type of security log entry has not been defined. In known systems, this would require the developer or other human user to manually identify which security log entries were not recognized, manually generate a new data pattern for recognizing that type of security log entry, and then deploy the new data pattern for use by the agents. The large amount of manual intervention of a user in this process provides a large source of potential errors the majority of which are avoided by the automated mechanisms of the illustrative embodiments for providing aids to users in generating new data patterns for unrecognized raw security log data structure entries. Moreover, such manual intervention increases the cost of deploying new audit-log generating solutions and may in fact slow their adoption.

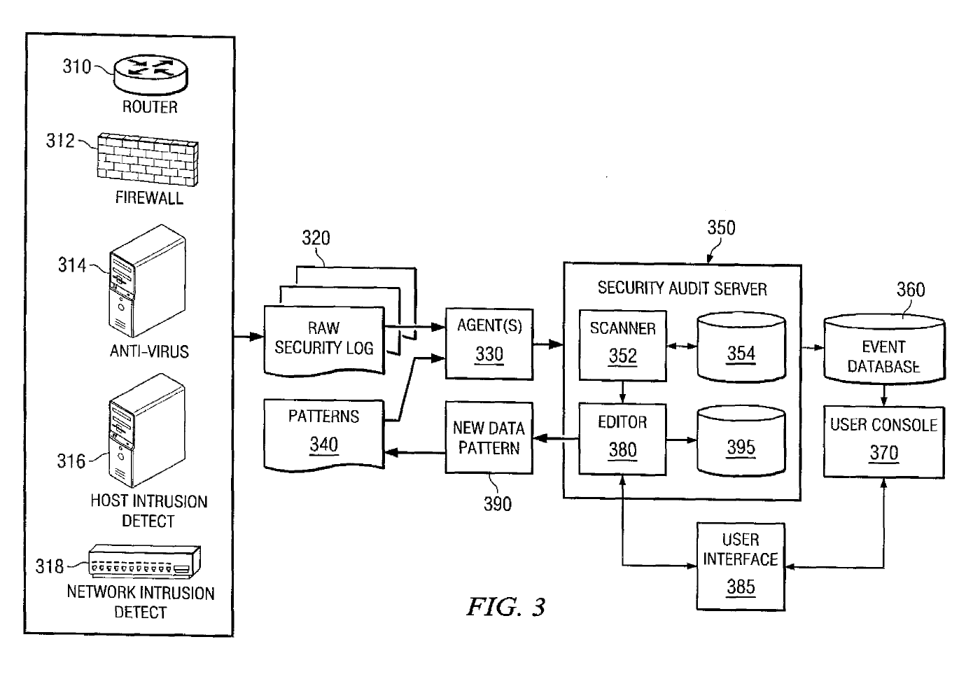

FIG. 3 is an exemplary diagram illustrating the primary operational components of an Information Technology (IT) security audit system in accordance with one illustrative embodiment. As shown in FIG. 3, a plurality of security devices 310-318 are provided which monitor security aspects of a data processing system, as is generally known in the art. These security devices 310-318 may comprise different types of security devices 310-318, e.g., a router, firewall, anti-virus mechanism, host intrusion detection mechanism, network intrusion mechanism, and the like. Alternatively, one or more of the security devices 310-318 may be different versions of the same security devices 310-318. In either case, the security devices 310-318 generate raw security log entries in one or more raw security log data structures 320. Because these security devices 310-318 are of different types, monitor different aspects of the security of the data processing system, and may include different versions of the security devices 310-318, the format of the data in entries of the raw security log data structures 320 may be different and thus will not be recognizable without definition of the data patterns of these different formats.

To facilitate recognition of the security data in the entries of the raw security log data structures 320, data patterns 340 are provided to the agents 330 which apply the data patterns to the entries in the raw security log data structures 320 to extract security data for use in reporting security events to the security audit server 350. These data patterns 340 may be a snapshot, or in memory copy, of data patterns stored in a data pattern database 395, for example. If a raw security log data structure 320 has an entry that is not recognizable by an agent 330, the agent 330 sends the unrecognized security log entry along with an indicator that the entry is not recognized to the security audit server 350.

The security audit server 350 includes a security log entry scanner 352 that has access to the same data patterns 340 as used by the agents 330, such as via data pattern database 395, for example, and applies portions of these defined data patterns, e.g., sub-patterns, to the unrecognized security log entry. These portions of the defined data patterns, or sub-patterns, may be associated with log attribute types in a log attribute database 354. The correspondence between sub-patterns and log attribute types in this log attribute database 354 allows log attribute types to be associated with recognized portions of the unrecognized security log entry. Moreover, new sub-patterns may be established and associated with log attribute types in the log attribute database 354 for later use in identified recognized portions of security log entries. Portions of the unrecognized security log entry matching the sub-patterns are identified and marked by the security log entry scanner 352 with other, non-marked, portions being the unrecognized portions of the unrecognized security log entry.

A user interface 385 displaying the unrecognized security log entries is generated via the editor 380 with the portions matching sub-patterns displayed in a manner that identifies the recognized portions to a user. Such a display may be provided via the console 370. The editor 380 may receive user input via the user interface 385 and a user input device (not shown) associated with the console 370. This user input may specify new sub-patterns for recognizing the previously unrecognized portions of the unrecognized security log entry. The user input may then associate these new sub-patterns and other previously defined sub-patterns with the unrecognized portions of the unrecognized security log entry. This association may be performed using the log attribute types and their entries in the log attribute type database 354 as described in greater detail hereafter. The combination of these new sub-patterns and previously defined sub-patterns as associated with the previously unrecognized portions of the unrecognized security log entry, as well as the sub-patterns associated with the recognized portions of the unrecognized security log entry, may be automatically used to generate a new data pattern 390 for recognizing security log entries of this format. These new data patterns 390 may be stored, such as in data pattern database 395, for use by the security audit server 350 as well as distribution to the agents 330 for use in analyzing the raw security log data structures 320.

Data extracted from recognized security log entries is used to generate security events that are stored in the event database 360. These events in the event database 360 may be stored for later analysis by automated mechanisms and/or output, via the console 370, for review by a system administrator or the like.

Thus, the mechanisms of the illustrative embodiments automatically identify portions of an unrecognized security log entry that match sub-patterns of pre-defined data patterns. A display of the security log entry via the editor 380 conspicuously identifies those portions of the security log entry that match pre-defined sub-patterns to aid the user in generating a new data pattern for use by the agents 330. In this way, the user need only associate sub-patterns with the unrecognized portions of the security log entry. This may require defining a new sub-pattern if an existing sub-pattern does not correspond to the unrecognized portion. Once a sub-pattern is associated with each portion of the unrecognized security log entry, the correspondence between sub-patterns and portions of the unrecognized security log entry may be used to automatically generate a new data pattern for use by the agents 330. In this way, the amount of manual recognition of portions of a security log entry, and manual input for defining new data patterns, is minimized and replaced with automated mechanisms. Moreover, the automated mechanisms of the illustrative embodiments further allow customization of the security rules used to identify security events from the security log data structures above and beyond those rules that may have been provided by the provider of the security devices 310-318 by providing new patterns for recognizing security events.

It should be appreciated that while an exemplary configuration of a system is shown in FIG. 3, the depiction is only exemplary and many modifications may be made without departing from the spirit and scope of the illustrative embodiments. For example, rather than the scanner 352 being implemented in the security audit server 350, the scanner may be present in the agents 330 and may scan the raw security log data structures 320 using a correspondence between attributes and sub-patterns as may be stored in the snapshot, or in memory version, of the data patterns 340 thereby eliminating the need for a separate database 354. Moreover, the data pattern database 395 may actually be integrated with the event database 360 and thus, a separate data pattern database 395 may not be necessary. Other configurations and modifications to the depicted example implementation may be made without departing from the spirit and scope of the illustrative embodiments or the present invention.

Having provided an overview of the mechanisms provided by the illustrative embodiments, specific illustrative embodiments with regard to particular types of security log entries, data pattern strings, and editor user interfaces will now be provided so as to provide additional details of the functionality of these mechanisms. It should be appreciated that while the following description and corresponding figures provide examples of these elements of the illustrative embodiments, these examples are not intended to be limiting on the present invention. To the contrary, other types of security log entries, having different formats, different syntax, different data types, etc., may be used without departing from the spirit and scope of the present invention. Similarly, different types of data pattern strings and editor user interfaces may also be sued without departing from the spirit and scope of the present invention.

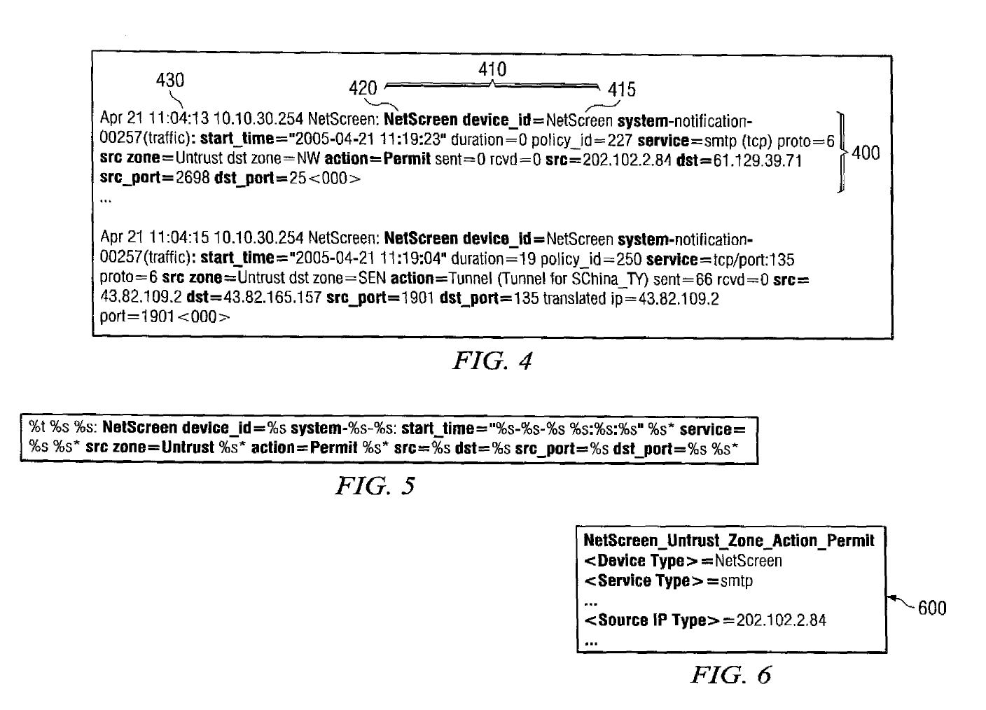

FIG. 4 is an exemplary diagram of a security log entry in a raw security log data structure in accordance with one illustrative embodiment. As shown in FIG. 4, the security log entry 400 is comprised of a plurality of log attributes 410. These log attributes 410 each have a variable field 415 and a constant field 420. The attributes are generally organized as pairs of constants and associated variables, e.g., “constant” =“variable.” In some cases only variable fields 415 may be specified, such as in the case of timestamps 430 or the like. A data pattern string for recognizing such a security log entry must define recognizable constant and variable strings for each of the log attributes 410 in the security log entry 400.

In known systems, security log entries such as that shown in FIG. 4 must be manually reviewed by a human user to identify security log entries that are not recognized by agents. It can be seen from FIG. 4 that each security log entry contains a large amount of text for representing each of the log attributes for each of the security log entries. In a raw security log data structure having a large number of these security log entries, it can be seen that it is very difficult for a human user to manually parse such a data structure to identify unrecognized security log entries and generate a data pattern for recognizing such security log entries.

FIG. 5 is an exemplary diagram of an exemplary data pattern string in accordance with one illustrative embodiment. The exemplary data pattern string shown in FIG. 5 matches the format of the security log entry 400 in FIG. 4. In a data pattern string such as that shown in FIG. 5, symbols that start with “%” represent variable fields. In the depicted example, the following variable fields are defined in the data pattern string:

%t defines a Date/Time type log attribute;

%s in “NetScreen device_id=%s” defines a device type log attribute variable;

%s in “service=%s” defines a service type log attribute variable;

%s in “src=%s” defines a source IP type log attribute variable; and

%s* means a variable-length string that, when encountered by an agent, the agent ignores all characters in the security log entry until a next constant field is read by the agent.

In known systems, a data pattern such as that shown in FIG. 5 must be manually generated by a human user in response to manually observing the security log entry shown in FIG. 4 in a raw security log data structure and determining that the security log entry is not recognized by the agent and a new data pattern needs to be generated. However, as discussed above, the illustrative embodiments provide automated mechanisms for aiding a user to define such a data pattern via a data pattern editor user interface. These automated mechanisms indicate to a user what portions of the security log entry are able to be recognized by sub-patterns of previously defined data patterns and which portions cannot be recognized.

The identification of recognized and unrecognized portions of a security log entry may be performed using sub-patterns of a data pattern, such as that shown in FIG. 5. These sub-patterns may be any portion of an overall data pattern, e.g., a string of characters within the data pattern string. In one illustrative embodiment, the sub-patterns are strings corresponding to constant-variable pairs or individual variables or constants. For example, a sub-pattern of the data pattern in FIG. 5 may be “NetScreen device_id=%s” or “system-%s-%s”.

Preferably, the sub-patterns correspond to log attributes that may be identified based on a matching of the sub-pattern to portions of the text string of a security log entry. It should be appreciated that since different types, versions, etc. of security monitoring devices may be used within the data processing system, these different security monitoring devices may not use the same constant or variable strings to designate the same security log attribute types. Thus, a log attribute database of security log attribute types and their corresponding sub-patterns defining constants and/or variables may be utilized that has entries that each correlate the various sub-patterns used by the different security monitoring devices with a same log attribute type.

For example, in one security monitoring device, a security log entry may be generated with “NetScreen device_id” as a constant of a log attribute having a log attribute type of “Device Type.” The log attribute type of “Device Type” may have an associated sub-pattern string of “Netscreen device_id=%s” for identifying such a log attribute in the security log entry generated by this first security monitoring device. Moreover, a second security monitoring device may generate a security log entry having “Screen_id” as a constant for a log attribute having a log attribute type of “Device Type.” The log attribute type of “Device Type” may have an associated sub-pattern string of “Screen_id=%s” for identifying such a log attribute in the security log entry generated by this second security monitoring device. Both sub-patterns may be associated with the log attribute type via the log attribute database.

The automated mechanisms further provide interfaces through which a user may associate a sub-pattern with portions of the security log entry and even define a new sub-pattern for associating with one or more portions of the security log entry. This new sub-pattern may be associated with an existing log attribute type or may be associated with a new log attribute type not previously defined in the log attribute database. In either case, when a new sub-pattern is defined by the user via these interfaces, the log attribute database is updated to include the new sub-pattern in association with its associated log attribute type. Thus, once a new sub-pattern is defined, it may be maintained in the log attribute database of the editor for later use in recognizing portions of other security log entries. Moreover, once each portion of the security log entry is associated with a sub-pattern, the combination of sub-patterns may be used to automatically generate a data pattern, such as that shown in FIG. 5, for recognition of the security log entry. This data pattern may be maintained by the editor and may be distributed to agents for use in recognizing security log entries in subsequent processing of security log data structures.

The data patterns, either previously defined or newly generated using the mechanisms of the illustrative embodiments, are used to identify security event data within a security log entry in a raw security log data structure. This security event data is used by the security audit server to generate security events which may be stored in a security event database for later processing and/or display to a user via a console. These security events may represent potential breaches to security of the data processing system, such as host intrusion attempts, network intrusion attempts, blocked data transfers, and the like. The generation of such security events and presentation of these security events to a system administrator may guide the system administrator with regard to actions to take to ensure the security of the data processing system.

FIG. 6 is an exemplary diagram of a security event generated based on a security log entry, such as shown in FIG. 4, and a predetermined data pattern string, such as shown in FIG. 5, in accordance with one illustrative embodiment. In the depicted example, the security log entry of FIG. 4 is identified by application of the data pattern string in FIG. 5, as a NetScreen_Untrust_Zone_Action_Permit event 600. The event 600 has identified event attributes such as “Device Type”, “Service Type”, and “Action Type.” These event attributes are extracted from the security log entry by recognition of these event attributes through the application of the data pattern from FIG. 5. That is, the event attributes correspond to log attributes of the data pattern. The label for the event attributes corresponds to the label of the identified log attribute type while the value for the event attributes corresponds to the variable associated with the portions of the security log entry that match the sub-pattern of the log attribute type. This event 600 may be stored in an event database for later processing and/or may be output to a user via a console or the like for the user's consideration.

As discussed above, the mechanisms of the illustrative embodiments provide an editor that aids a user in defining new data patterns for recognition of security log entries. This editor generates a display of unrecognized security log entries, as identified by the security audit agents, in a manner in which the recognized and unrecognized portions of the security log entry are visually identified to the user. In one illustrative embodiment, this visual identification may take the form of log attribute callouts.

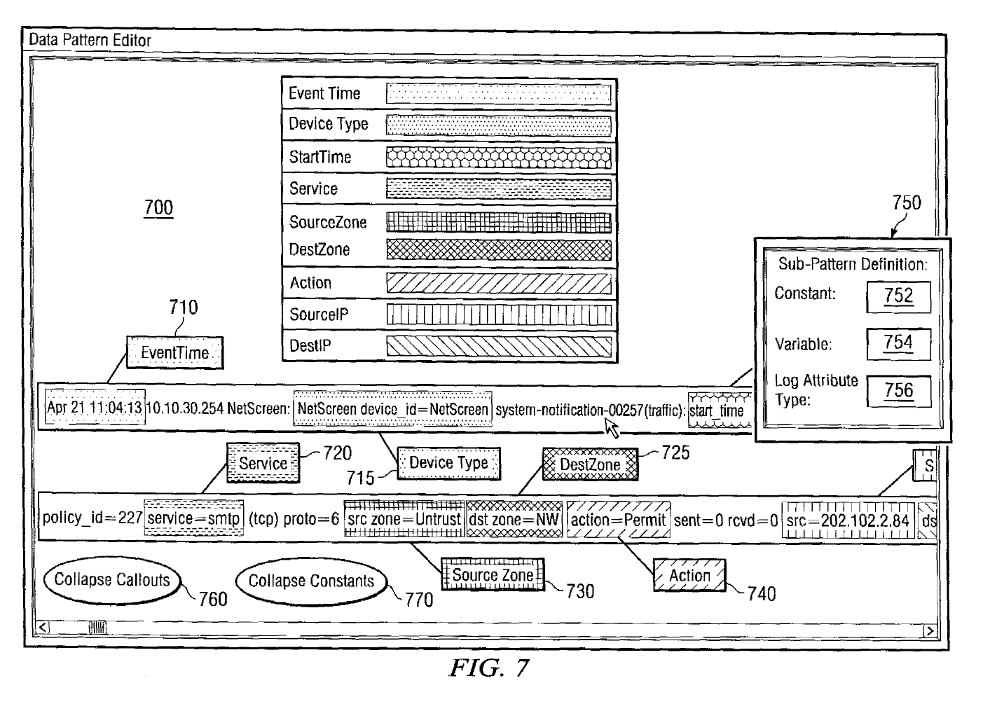

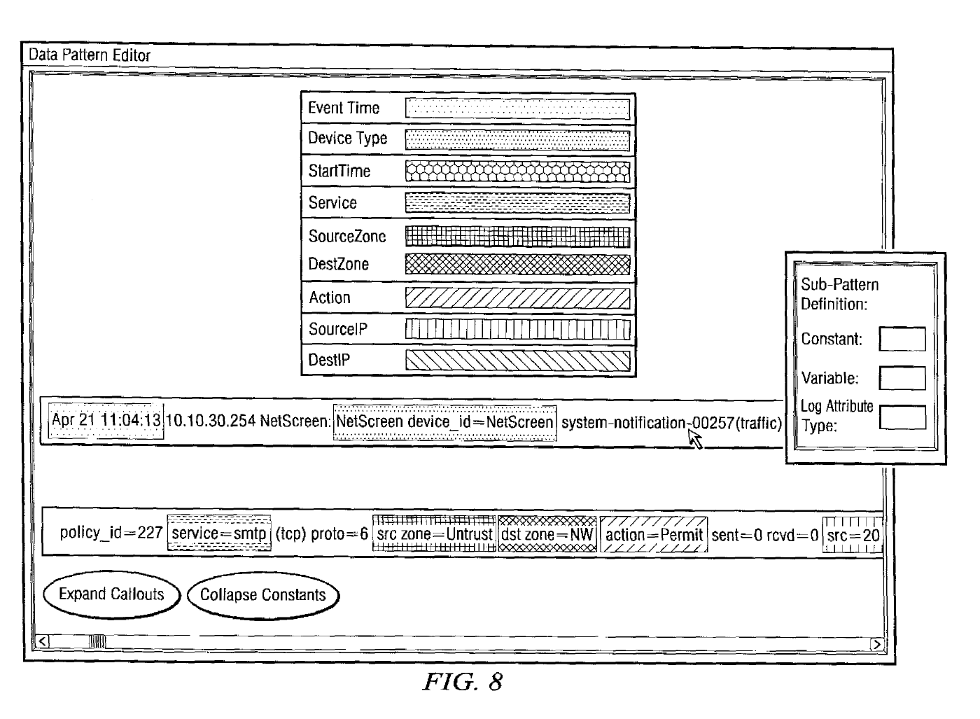

FIG. 7 is an exemplary diagram illustrating a display of an editor view with a log attribute callout in accordance with one illustrative embodiment. As shown in FIG. 7, portions of the security log entry 700 that have data formats matching a sub-pattern of a pre-defined data pattern are identified by way of a log attribute callout box 710-740. The log attribute callout boxes 710-740 may specify the log attribute type label associated with the matching sub-pattern and may have a graphical representation that clearly indicates the portion of the security log entry to which the log attribute callout box 710-740 corresponds, e.g., by way of a line from the attribute callout box 710-740 to the portion of the security log entry in the depicted example. Moreover, the log attribute callout boxes 710-740 may be color coded or otherwise made distinguishable from each other, such as by highlighting, flashing, different patterns, or the like, based on the log attribute types to which they correspond. In one illustrative embodiment, the colors or other distinguish characteristics used to represent the log attribute callout boxes 710-740 may be assigned to ranges of data, i.e. ranges of data representing different levels of potential security issues, e.g., green representing an “okay” zone, time frame, data source, etc., while yellow represents an unsure range of data, and red representing an undesirable range of data. In this way, a single color based rating of the security record may be built up. If the record is mostly green, for example, then it is “okay” and does not represent a serious security event. If the record is mostly red, then a serious security event has happened even though the record may have some previously unrecognized portions with the record.

In this way, a user may be able to quickly identify which portions of the security log entry are recognizable and what types of log attribute types the various portions of the security log entry corresponds with. In addition, those portions of the security log entry that do not have associated log attribute callout boxes 710-740 can be quickly identified as those portions that are not recognizable.

For those portions that are not recognizable, a user may click on, or highlight, the portion using a user input device, e.g., a mouse, keyboard, or the like, and initiate a process for defining a new sub-pattern for that portion of the security log entry. This process may involve the editor providing another interface 750 for defining a new sub-pattern by, for example, specifying a constant 752 and an associated variable 754. Moreover, a field 756 may be provided in this interface for specifying a log attribute type to be associated with the sub-pattern. This may be an already existing log attribute type or may be a newly defined log or event attribute type. If it is an existing log attribute type, then the new sub-pattern is added in association with the existing log attribute type in the log attribute database such that when it is encountered during a scan of a security log entry, the corresponding log attribute type will be identified. If it is a new log attribute type, a new entry in the log attribute database may be generated with the new log attribute type and the associated sub-pattern being stored in this new entry.

Various modifications to the display of the unrecognized security log entry may be made without departing from the spirit and scope of the present invention. Moreover, user selectable options may be provided via the editor's user interface to modify the manner by which the security log entry is displayed. For example, to make the data pattern of the security log entry more readable, the user can select an option 760 for collapsing the log attribute callout boxes. In such a display, the portions of the unrecognized security log entry that match sub-patterns may be highlighted, represented with different text color, or the like, using a color, pattern or the like associated with the log attribute type corresponding to that portion of the security log entry. FIG. 8 is an exemplary diagram illustrating a display of an editor view in which callout boxes are collapsed in accordance with one illustrative embodiment.

Other modifications to the display of the security log entry in the editor may be made using user selectable options. For example, another user selectable option 770 may be used to collapse the constants in the security log entry's display so that they are not visible to the user. To the contrary, symbols, such as ellipsis, may be provided in place of these constants. Moreover, “do not care” variables, i.e. variables whose values are not relevant to the user, may be automatically collapsed in response to a user selection of a user interface element, e.g., variables associated with the %s* tag. Many different types of modifications may be made to the display of the security log entry and many different types of user interface elements for facilitating such changes to a display of a security log entry may be made without departing from the spirit and scope of the present invention.

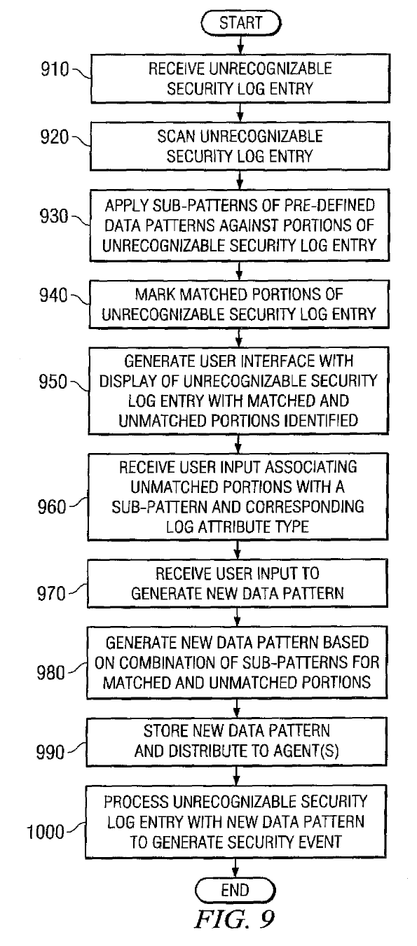

FIG. 9 is a flowchart outlining an exemplary operation for editing a security log pattern in accordance with one illustrative embodiment. The operation outlined in FIG. 9 may be performed by a security audit server in response to an agent identifying an unrecognizable security log entry from a raw security log data structure. As shown in FIG. 9, the operation starts with receiving the unrecognizable security log entry (step 910). The unrecognizable security log entry is scanned (step 920) and sub-patterns of pre-defined data patterns are applied against portions of the unrecognizable security log entry to identify matched portions (step 930). The matched portions are marked with identifiers of log attribute types corresponding to the sub-patterns that matched those portions (step 940). A user interface is generated with a display of the unrecognizable security log entry with the matched portions being displayed with identifiers of the log attribute types corresponding to the match portions and unmatched portions not having the identifiers of log attribute types (step 950).

User input is received for associating the unmatched portions with a sub-pattern and corresponding log attribute type (step 960). As described above, this may involve the user utilizing a user interface to define a new sub-pattern and corresponding log attribute type. Alternatively, if a log attribute type is already defined that may be used with that portion of the unrecognizable security log entry, that log attribute type may be associated with the portion via user input and the user interface. Moreover, a new-sub pattern may be defined and associated with an already existing log attribute type.

A user input is received instructing the editor to generate a new data pattern based on the presently displayed unrecognized security log entry and the log attributes associated with portions of the unrecognized security log entry (step 970). The log attribute types and their corresponding sub-patterns for both the recognized portions and unrecognized portions of the unrecognizable security log entry are combined to generate a new data pattern comprising a combination of all of the sub-patterns (step 980). This new data pattern is stored for later use in processing subsequent security log entries as well as for distribution to security audit agents (step 990). Moreover, the security log entry may be processed using this new data pattern to generate a security event that is stored in an event database for later processing and/or output to a user via a console (step 1000). The operation then terminates.

Thus, the illustrative embodiments provide mechanisms for assisting users in the identification of security log entries that are not recognized by security audit agents based on existing data patterns. Moreover, the illustrative embodiments provide mechanisms for assisting users in defining new data patterns for such security log entries. The mechanisms provide guidance as to which portions of the security log entries are recognized by portions of existing data patterns and which portions of the security log entries are not recognized in this manner. Moreover, user interfaces are provided for assisting the user in generating new sub-patterns for association with the unrecognized portions such that new data patterns may be automatically generated based on a combination of sub-patterns corresponding to recognized portions of the unrecognized security log entry and sub-patterns that the user now associates with the previously unrecognized portions of the security log entry.

As noted above, it should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for processing a security log data structure entry, comprising:
receiving an unrecognized security log entry, wherein the unrecognized security log entry is an entry in a raw security log data structure that is not able to be recognized by security audit agents based on already defined data patterns;
identifying first portions of the unrecognized security log entry that are recognized based on the already defined data patterns and second portions of the unrecognized security log entry that are not recognized;
providing a first user interface for receiving user input associating sub-patterns to the second portions of the unrecognized security log entry, wherein the first user interface identifies the first portions of the unrecognized security log entry as being recognized;
generating a new data pattern based on the association of sub-patterns to the second portions of the unrecognized security log entry; and
applying the new data pattern to a subsequent security log entry in one or more raw security log data structures to thereby extract security event data for generation of a security event.

2. The method of claim 1, wherein identifying first portions and second portions of the unrecognized security log entry comprises:
applying pre-defined sub-patterns of the already defined data patterns to portions of the unrecognized security log entry; and
determining if the pre-defined sub-patterns match one or more of the portions of the unrecognized security log entry, wherein if a pre-defined sub-pattern matches a portion of the unrecognized security log entry, the portion is marked as a first portion of the unrecognized security log entry and the pre-defined sub-pattern is associated with the portion.

3. The method of claim 2, wherein the new data pattern is generated based on a combination of pre-defined sub-patterns matching first portions of the unrecognized security log entry and sub-patterns associated with the second portions of the unrecognized security log entry.

4. The method of claim 1, further comprising:
receiving user input for associating a log attribute type, from a plurality of defined log attribute types, with one or more of the first portions and second portions of the unrecognized security log entry, wherein the log attribute type has an associated sub-pattern.

5. The method of claim 4, further comprising:
providing a second user interface for defining a new log attribute type to be added to the plurality of defined log attribute types, the new log attribute type having an associated sub-pattern; and
associating the new log attribute type with one or more of the second portions of the unrecognized security log entry.

6. The method of claim 4, wherein the first user interface displays a copy of the unrecognized security log entry and identifies the first portions of the unrecognized security log entry as being recognized by displaying an indication of log attribute types associated with the first portions in the first user interface in association with a display of the first portions, and wherein the second portions are displayed without an indication of any associated log attribute types.

7. The method of claim 6, wherein the indication of log attribute types is color coded based on the log attribute type with each log attribute type having a different color for display of the log attribute type's indicator.

8. The method of claim 6, wherein the unrecognized security log entry comprises a plurality of log attributes having constant-variable pairs, and wherein the display of the copy of the unrecognized security log entry compresses the constants of the constant-variable pairs such that they are not displayed.

9. The method of claim 6, wherein the indication of log attribute types comprises call-out boxes with lines associating the call-out boxes with their associated first portions, and wherein the call-out boxes display a name of the log attribute type.

10. A computer program product comprising a computer recordable medium having a computer readable program recorded thereon, wherein the computer readable program, when executed on a computing device, causes the computing device to:
receive an unrecognized security log entry, wherein the unrecognized security log entry is an entry in a raw security log data structure that is not able to be recognized by security audit agents based on already defined data patterns;
identify first portions of the unrecognized security log entry that are recognized based on the already defined data patterns and second portions of the unrecognized security log entry that are not recognized;
provide a first user interface for receiving user input associating sub-patterns to the second portions of the unrecognized security log entry, wherein the first user interface identifies the first portions of the unrecognized security log entry as being recognized;
generate a new data pattern based on the association of sub-patterns to the second portions of the unrecognized security log entry; and
apply the new data pattern to a subsequent security log entry in one or more raw security log data structures to thereby extract security event data for generation of a security event.

11. The computer program product of claim 10, wherein the computer readable program causes the computing device to identify first portions and second portions of the unrecognized security log entry by:
applying pre-defined sub-patterns of the already defined data patterns to portions of the unrecognized security log entry; and
determining if the pre-defined sub-patterns match one or more of the portions of the unrecognized security log entry, wherein if a pre-defined sub-pattern matches a portion of the unrecognized security log entry, the portion is marked as a first portion of the unrecognized security log entry and the pre-defined sub-pattern is associated with the portion.

12. The computer program product of claim 11, wherein the new data pattern is generated based on a combination of pre-defined sub-patterns matching first portions of the unrecognized security log entry and sub-patterns associated with the second portions of the unrecognized security log entry.

13. The computer program product of claim 10, wherein the computer readable program further causes the computing device to:
receive user input for associating a log attribute type, from a plurality of defined log attribute types, with one or more of the first portions and second portions of the unrecognized security log entry, wherein the log attribute type has an associated sub-pattern.

14. The computer program product of claim 13, wherein the computer readable program further causes the computing device to:
provide a second user interface for defining a new log attribute type to be added to the plurality of defined log attribute types, the new log attribute type having an associated sub-pattern; and
associate the new log attribute type with one or more of the second portions of the unrecognized security log entry.

15. The computer program product of claim 13, wherein the first user interface displays a copy of the unrecognized security log entry and identifies the first portions of the unrecognized security log entry as being recognized by displaying an indication of log attribute types associated with the first portions in the first user interface in association with a display of the first portions, and wherein the second portions are displayed without an indication of any associated log attribute types.

16. The computer program product of claim 15, wherein the indication of log attribute types is color coded based on the log attribute type with each log attribute type having a different color for display of the log attribute type's indicator.

17. The computer program product of claim 15, wherein the unrecognized security log entry comprises a plurality of log attributes having constant-variable pairs, and wherein the display of the copy of the unrecognized security log entry compresses the constants of the constant-variable pairs such that they are not displayed.

18. The computer program product of claim 15, wherein the indication of log attribute types comprises call-out boxes with lines associating the call-out boxes with their associated first portions, and wherein the call-out boxes display a name of the log attribute type.

19. An apparatus, comprising:
a processor; and
a memory coupled to the processor, wherein the memory comprises instructions which, when executed by the processor, cause the processor to:
receive an unrecognized security log entry, wherein the unrecognized security log entry is an entry in a raw security log data structure that is not able to be recognized by security audit agents based on already defined data patterns;
identify first portions of the unrecognized security log entry that are recognized based on the already defined data patterns and second portions of the unrecognized security log entry that are not recognized;
provide a first user interface for receiving user input associating sub-patterns to the second portions of the unrecognized security log entry, wherein the first user interface identifies the first portions of the unrecognized security log entry as being recognized;
generate a new data pattern based on the association of sub-patterns to the second portions of the unrecognized security log entry; and
apply the new data pattern to a subsequent security log entry in one or more raw security log data structures to thereby extract security event data for generation of a security event.

20. The apparatus of claim 19, wherein the instructions cause the processor to identify first portions and second portions of the unrecognized security log entry by:
applying pre-defined sub-patterns of the already defined data patterns to portions of the unrecognized security log entry; and
determining if the pre-defined sub-patterns match one or more of the portions of the unrecognized security log entry, wherein if a pre-defined sub-pattern matches a portion of the unrecognized security log entry, the portion is marked as a first portion of the unrecognized security log entry and the pre-defined sub-pattern is associated with the portion.

21. The apparatus of claim 20, wherein the new data pattern is generated based on a combination of pre-defined sub-patterns matching first portions of the unrecognized security log entry and sub-patterns associated with the second portions of the unrecognized security log entry.

22. The apparatus of claim 19, wherein the instructions further cause the processor to:
receive user input for associating a log attribute type, from a plurality of defined log attribute types, with one or more of the first portions and second portions of the unrecognized security log entry, wherein the log attribute type has an associated sub-pattern.

23. The apparatus of claim 22, wherein the instructions further cause the processor to:
provide a second user interface for defining a new log attribute type to be added to the plurality of defined log attribute types, the new log attribute type having an associated sub-pattern; and
associate the new log attribute type with one or more of the second portions of the unrecognized security log entry.

24. The apparatus of claim 22, wherein the first user interface displays a copy of the unrecognized security log entry and identifies the first portions of the unrecognized security log entry as being recognized by displaying an indication of log attribute types associated with the first portions in the first user interface in association with a display of the first portions, and wherein the second portions are displayed without an indication of any associated log attribute types.

25. The apparatus of claim 24, wherein the indication of log attribute types is color coded based on the log attribute type with each log attribute type having a different color for display of the log attribute type's indicator.

26. The apparatus of claim 24, wherein the unrecognized security log entry comprises a plurality of log attributes having constant-variable pairs, and wherein the display of the copy of the unrecognized security log entry compresses the constants of the constant-variable pairs such that they are not displayed.

27. The apparatus of claim 24, wherein the indication of log attribute types comprises call-out boxes with lines associating the call-out boxes with their associated first portions, and wherein the call-out boxes display a name of the log attribute type.
